(19) United States
(12) Patent Application Publication
(10) Pub. No.: US 2012/0246235 A1
(43) Pub. Date: Sep. 27, 2012

(54) ATTRIBUTE INFORMATION SHARING PROVIDING SYSTEM, ACCESS INFORMATION MANAGEMENT DEVICE, ACCESS INFORMATION PROXY MANAGEMENT DEVICE, METHOD AND PROGRAM THEREFOR

(75) Inventor: Makoto Hatakeyama, Minato-ku (JP)

(73) Assignee: NEC CORPORATION, Minato-ku, Tokyo (JP)

(21) Appl. No.: 13/514,238

(22) PCT Filed: Nov. 11, 2010
(86) PCT No.: PCT/JP2010/006631

§ 371 Date: Jun. 6, 2012

(30) Foreign Application Priority Data
Dec. 7, 2009 (JP) 2009-277951

(51) Int. Cl. G06F 15/16

(52) U.S. Cl. 709/204

(57) ABSTRACT

An attribute information providing device 510 manages attribute information being information related to each user and provides the same to another device. An access information management device 530 manages first access information for accessing the attribute information providing device 510 from an attribute information acquisition device 520. An access information proxy management device 540 manages second access information for accessing the access information management device 530 from the attribute information acquisition device 520. The attribute information acquisition device 520 acquires attribute information from the attribute information providing device 510, based on the second access information acquired from the access information proxy management device 540 and first access information acquired from the access information management device 530.

### TECHNICAL FIELD

The present invention relates to an attribute information sharing providing system, an access information management device, an access information proxy management device, a method and a program that cause a plurality of devices provide to other devices in conjunction with one another attribute being information related to users.

### BACKGROUND ART

Non-Patent Document 1 describes one example of an attribute information management system that manages attribute information being information related to each user. FIG. 20 is an explanatory diagram showing the outline of the attribute information management system described in the Non-Patent Document 1. As shown in FIG. 20, the attribute information management system described in the Non-Patent Document 1 includes a WSP (Web Service Provider) 100, a WSC (Web Service Consumer) 101, a DS (Discovery Service) 102, and a User Agent (software for user terminal) connected to one another via a communication network.

A procedure for managing attribute information using the DS 102 will be explained as a typical operation of the attribute information management system described in the Non-Patent Document 1, which has the configuration as described above.

In FIG. 20, a user registers attribute information in the WSP 100 through the User Agent 103 ((1) shown in FIG. 20). The WSP 100 stores the attribute information therein and sends to the DS 102 ((2) shown in FIG. 20) information for allowing another device to access the attribute information. The DS 102 receives the access information being the information for accessing the sent attribute information and stores the same therein. With this processing, the registration of the attribute information by the user is completed.

A case will be discussed where in the above state, the User Agent 103 obtains access to the WSC 101 ((3) shown in FIG. 20) and the WSC 101 needs the user's attribute information. To obtain information for accessing attribute information, the WSC 101 sends an access information request to the DS 102 ((4) shown in FIG. 20). The DS 102 having received the corresponding request therein provides the access information received from the WSP 100 and stored therein to the WSC 101 ((5) shown in FIG. 20). The WSC 101 finds or detects the WSP 100 that holds the attribute information, based on the information described in the access information ((6) shown in FIG. 20). Thereafter, the WSC 101 requires the WSP 100 to send attribute information to obtain the same.

As described above, the WSC 101 can detect the attribute information by allowing the DS 102 to centralizedly manage the information for accessing the attribute information.

Patent Document 1 describes a data transmission control system for detecting attribute information. FIG. 21 is an explanatory diagram showing the outline of the data transmission control system described in the Patent Document 1. As shown in FIG. 21, the data transmission control system described in the Patent Document 1 includes a terminal 200, a data send-receive control device 201 and a data management device 202.

The system for detecting the attribute information, having such a configuration, which system has been described in the Patent Document 1, is operated as follows:

The terminal 200 sends a request for the transmission of data to the data send-receive control device 201 upon request of the data. The data send-receive control device 201 detects a plurality of data management devices 202 holding data required by the terminal 200 through the data management devices, using access information being information for accessing the data management devices 202 each managed by itself. Thereafter, the data send-receive control device 201 requires each data management device 202 to send data. The data management device 202 having received the request sends data to the terminal 200.

As in the attribute information management system described in the Non-Patent Document 1 and the data transmission control system described in the Patent Document 1, access information being information for accessing, which has been registered in advance, is retrieved upon detecting attribute information held in a given information management device. A device actually having attribute information is detected based on the access information, and a request related to the attribute information is sent to the corresponding device.

Here, the access information is information that includes a user identifier, a URL (Uniform Resource Locator) for accessing a server which manages attribute information, the type of stored attribute information, a condition for accessing, etc. The attribute information is a set of information indicative of the character of each user. The attribute information includes not only information for uniquely specifying each user, such as the name, address, telephone number and E-mail address thereof, but also information uniquely unlinked to the user, such as hobbies, preference and an access history. The attribute information includes information related to each user.

### CITATION LIST

### Patent Literature

Patent Document 1 JP-A-2006-31539 (paragraphs 0031-0177 and FIG. 2)
Non-Patent Document 1 Liberty Alliance Project, “Liverty Identity Web Services Framework (ID-WSF) V2.0” [online], Jul. 9, 2007 [retrieved on June 30, Hei. 21 (2001)], Internet <URL http://www.projectliberty. org/resource_center/specifications/liberty_alliance_id_wsf_{—}2_{—}0_specifications_including_errata_v1_{—}0_updates>

### SUMMARY OF INVENTION

### Technical Problem

A first problem is involved in the attribute information management system described in the Non-Patent Document 1 and the data transmission control system described in the Patent Document 1. The first problem resides in that when there exist a plurality of DSs being devices that store access information necessary for other devices to obtain access to attribute information, it is not possible to determine in which device (DS) a WSP indicative of a device for managing attribute information may register access information.

This is because the device that manages the attribute information does not manage information for determining to which device the access information may be distributed. The information for such a determination is, for example, information about in which device a user having registered attribute information therein has a user account, etc. If the attribute information management device sends the access information to all devices, it is then unnecessary to make such a determination. When the access information is however sent to all the devices, the access information is registered even in each device unused by the user, thus resulting in inefficiency. Since the number of servers that manage access information increases, the risk of leakage of the attribute information increases.

A second problem is involved in the attribute information management system described in the Non-Patent Document 1 and the data transmission control system described in the Patent Document 1. The second problem resides in that when there exist a plurality of DSs being devices that store access information therein, it is not possible to determine from which device a WSC being a device that acquires attribute information may acquire access information.

This is because the device that acquires the attribute information does not grasp which device holds access information being information for accessing the device that manages the attribute information. If the transmission of access information is required of all devices, then necessary information can be obtained, but the transmission of the access information is required even of each device having no access information, thus resulting in inefficiency.

A third problem is involved in the attribute information management system described in the Non-Patent Document 1 and the data transmission control system described in the Patent Document 1. The third problem resides in that when access information is shared between a plurality of servers, a problem on the leakage of information is likely to rise.

This is because a device that acquired information described in access information can easily obtain attribute information held by a device that manages attribute information. Since the attribute information of each user is of information linked to each individual user, it is necessary to prevent the leakage of information in terms of privacy protection.

The present invention aims to provide an attribute information sharing providing system, an access information management device, an access information proxy management device, a method and a program that enable devices which manage attribute information to register access information efficiently. The present invention also aims to provide an attribute information sharing providing system, an access information management device, an access information proxy management device, a method and a program that enable devices which acquire attribute information to obtain access information efficiently. Further, the present invention aims to provide an attribute information sharing providing system, an access information management device, an access information proxy management device, a method and a program capable of achieving a safety attribute information exchange that protects the privacy of each user.

### Solution to Problem

An attribute information sharing providing system according to the present invention comprises an attribute information providing device which manages attribute information being information related to each user and provides the attribute information to another device; an attribute information acquisition device corresponding to another device, the attribute information acquisition device acquiring the attribute information from the attribute information providing device; an access information management device which manages first access information for accessing the attribute information providing device from the attribute information acquisition device; and an access information proxy management device which manages second access information for accessing the access information management device from the attribute information acquisition device, wherein the attribute information providing device includes first access information issuing means which when attribute information is registered, issues first access information for accessing the corresponding attribute information providing device and sends the first access information to the access information management device, wherein the access information management device includes second access information issuing means which when the first access information is received from the attribute information providing device, issues second access information for accessing the corresponding access information management device itself and sends the second access information to the access information proxy management device, and first access information sending means which sends the first access information according to a request of the attribute information acquisition device, wherein the access information proxy management device includes second access information sending means which manages the second access information sent by the access information management device and sends the second access information when the transmission of access information is requested from the attribute information acquisition device, wherein the attribute information acquisition device includes second access information acquiring means which requires the access information proxy management device to send access information and receives the second access information sent according to the request, first access information acquiring means which requires the access information management device to send access information, based on the second access information acquired by the second access information acquiring means and receives the first access information sent according to the request, and attribute information acquiring means which requires the attribute information providing device to send the attribute information, based on the first access information acquired by the first access information acquiring means and acquires the attribute information sent according to the request.

An access information management device according to the present invention comprises access information management means which manages first access information for accessing an attribute information providing device which manages attribute information being information related to each user, the first access information being issued by the attribute information providing device; second access information issuing means which generates second access information descriptive of information for accessing a corresponding access information management device and sends the second access information to an access information proxy management device, the access information proxy management device sending the second access information to an attribute information acquisition device using the attribute information; and first access information sending means which sends the first access information corresponding to a request of the attribute information acquisition device having acquired the second access information from the access information proxy management device.

An access information proxy management device according to the present invention comprises access information proxy management means which manages access information for accessing an access information management device, which is received from the access information management device, the access information management device sending information for accessing an attribute information providing device that manages attribute information being information related to each user, to the attribute information acquisition device using the attribute information; access information retrieving means which when the transmission of access information is requested from the attribute information acquisition device, acquires access information corresponding to the request from the access information proxy management means; and sending/receiving means which sends the access information acquired by the access information retrieving means to the attribute information acquisition device.

An access information managing method according to the present invention comprises generating first access information for accessing a corresponding attribute information providing device itself which manages attribute information being information related to each user, the first access information being issued by the attribute information providing device, and sending the first access information to an access information management device which sends the first access information to a corresponding attribute information acquisition device using the attribute information; generating second access information for accessing a corresponding access information management device itself, which is issued by the access information management device, and sending the second access information to an access information proxy management device which sends the second access information to the attribute information acquisition device; sending the second access information corresponding to a request of the attribute information acquisition device to the attribute information acquisition device; sending first access information corresponding to a request of the attribute information acquisition device having acquired the second access information to the attribute information acquisition device; and sending attribute information corresponding to a request of the attribute information acquisition device having acquired the first access information to the corresponding attribute information acquisition device.

An access information proxy managing method according to the present invention comprises storing access information acquired from an access information management device which sends information for accessing an attribute information providing device that manages attribute information being information related to each user, to the attribute information acquisition device using the attribute information; and when the transmission of access information is requested from the attribute information acquisition device, sending the access information corresponding to the request, of the stored access information to the attribute information acquisition device.

An access information managing program according to the present invention causes a computer to execute an access information managing process for managing first access information for accessing an attribute information providing device that manages attribute information being information related to each user, the first access information being issued by the attribute information providing device, a second access information issuing process for generating second access information descriptive of information for accessing a corresponding access information management device itself which sends information for accessing an attribute information providing device and for sending the second access information to an access information proxy management device that sends the second access information to the attribute information acquisition device using the attribute information, and a first access information sending process for when the transmission of access information is requested from an attribute information acquisition device having acquired the second access information, sending first access information corresponding to the request to the attribute information acquisition device.

An access information proxy managing program according to the present invention causes a computer to execute an access information proxy managing process for storing access information acquired from an access information management device which sends information for accessing an attribute information providing device that manages attribute information being information related to each user, to the attribute information acquisition device using the attribute information; an access information retrieving process for when the transmission of access information is requested from the attribute information acquisition device, acquiring the access information corresponding to the request, of the stored access information; and a process for sending the access information acquired at the access information retrieving process to the attribute information acquisition device.

### Advantageous Effects of the Invention

According to the present invention, an attribute information providing device that provide attribute information can register access information efficiently. This is because since an access information management device provides access information to another access information proxy management device if the attribute information providing device provides access information to one access information management device, the attribute information providing device needs not to provide the access information to a plurality of access information management devices.

According to the present invention as well, the attribute information providing device can obtain access to attribute information efficiently. This is because when the attribute information acquisition device acquires access information to the attribute information, there is no need to require an unspecified number of access information management devices to send the access information, and the access information to the attribute information can be obtained by requiring one access information proxy management device and one access information management device to send the access information.

According to the present invention, the privacy of each user related to the attribute information can be protected even if an access information management device discloses access information to another device. This is because the access information that the access information management device provides to another device includes only the access information to the corresponding access information management device but does not include access information to the attribute information management device. Thus, since the information for accessing the attribute information is not contained in the access information that the access information proxy management device has received from the access information management device, the access to the attribute information is limited.

### BRIEF DESCRIPTION OF DRAWINGS

FIG. 1 It depicts a block diagram showing a configuration example of an exemplary embodiment 1 of an attribute information sharing providing system according to the present invention;

FIG. 2 It depicts a block diagram showing a configuration example of an access information management device;

FIG. 3 It depicts an explanatory diagram illustrating an example of a list of attribute information acquisition devices;

FIG. 4 It depicts an explanatory diagram depicting a list of access information proxy management devices stored in an attribute information acquisition device information storing means;

FIG. 5 It depicts an explanatory diagram showing information of IDs stored in a user information management means;

FIG. 6 It depicts a block diagram showing a configuration example of an access information proxy management device;

FIG. 7 It depicts a flowchart showing an operation for providing attribute information sent by a user terminal to an attribute information acquisition device;

FIG. 8 It depicts a sequence diagram showing a process for providing attribute information sent by the user terminal to the attribute information acquisition device;

FIG. 9 It depicts a flowchart illustrating a process for registering attribute information in advance;

FIG. 10 It depicts a flowchart depicting a process for registering access information by an access information management device;

FIG. 11 It depicts a flowchart showing a process for acquiring access information by the attribute information acquisition device;

FIG. 12 It depicts a block diagram depicting a configuration example of an exemplary embodiment 2 of an attribute information sharing providing system according to the present invention;

FIG. 13 It depicts a block diagram showing a configuration example of an access information management device;

FIG. 14 It depicts a flowchart illustrating a process for attribute information advanced registration in the exemplary embodiment 2;

FIG. 15 It depicts a flowchart showing a process for registering access information by the access information management device in the exemplary embodiment 2;

FIG. 16 It depicts a flowchart depicting an access information acquiring process in the exemplary embodiment 2;

FIG. 17 It depicts a block diagram showing a configuration example of an exemplary embodiment 3 of an attribute information sharing providing system according to the present invention;

FIG. 18 It depicts an explanatory diagram illustrating a configuration of an example of an attribute information sharing providing system according to the present invention;

FIG. 19 It depicts a block diagram depicting a summary of the present invention;

FIG. 20 It depicts an explanatory diagram showing the outline of the attribute information management system described in the Non-Patent Document 1; and

FIG. 21 It depicts an explanatory diagram showing the outline of the data transmission control system described in the Patent Document 1.

### DESCRIPTION OF EMBODIMENTS

### Exemplary Embodiment 1

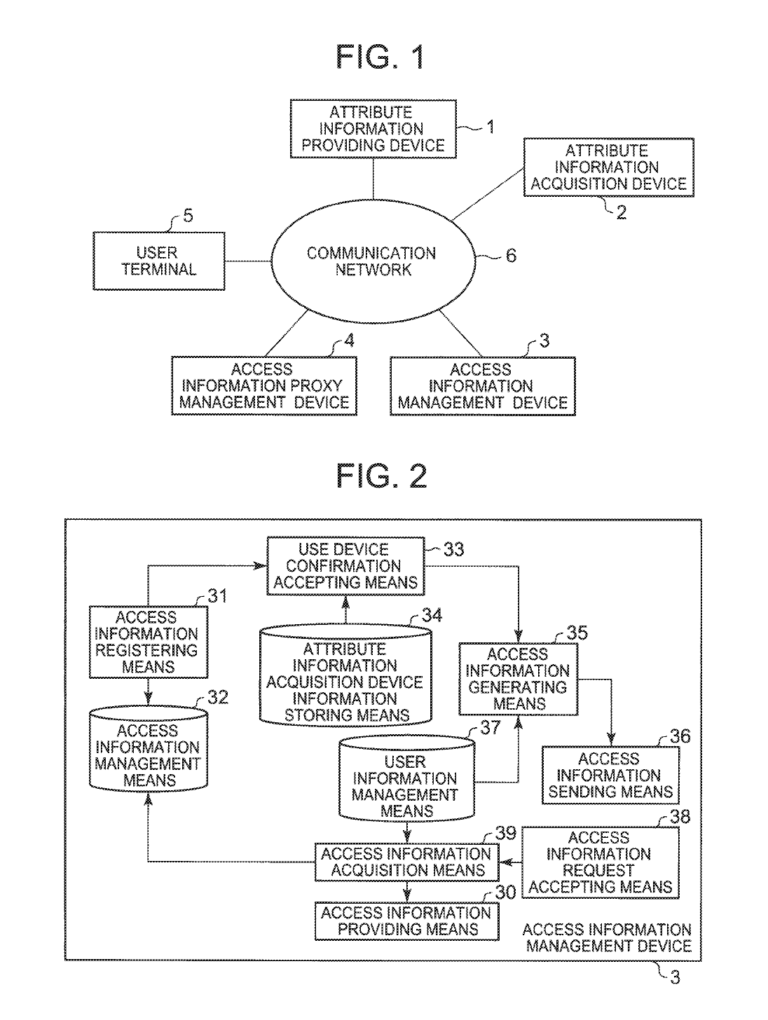

An exemplary embodiment 1 of an attribute information sharing providing system according to the present invention will be explained with reference to the accompanying drawings. FIG. 1 is a block diagram showing a configuration example of the exemplary embodiment 1 of the attribute information sharing providing system according to the present invention. As shown in FIG. 1, the attribute information sharing providing system of the exemplary embodiment 1 of the present invention includes an attribute information providing device 1, an attribute information acquisition device 2, an access information management device 3 and an access information proxy management device 4. The respective devices are connected to a communication network 6 to which a user terminal 5 is connected.

The attribute information providing device 1 manages attribute information and sends the attribute information to the attribute information acquisition device 2. That is, the attribute information providing device 1 sends the same thereto. The attribute information providing device 1 generates first access information being access information corresponding to information necessary to acquire the attribute information and sends the same to the access information management device 3.

The attribute information acquisition device 2 requires the access information management device 3 and access information proxy management device 4 determined in advance to send first access information and second access information to be described later both being access information for acquiring attribute information to acquire them, and requires the attribute information management device 1 to send attribute information, based on the acquired access information to obtain the same. Described specifically, the attribute information management device 1 receives attribute information sent according to a transmission request. Incidentally, the attribute information acquisition device 2 is assumed to have previously stored information about the access information proxy management device 4 and the access information management device 3 being devices that require the transmission of access information foremost.

Incidentally, in the present invention, the type of attribute information for the access information means the type of content of information contained in the attribute information. For example, the above-described name, telephone number and the like belong thereto. A condition for performing access for access information means a condition for holding or utilizing attribute information such as the usage purpose thereof, a provider thereof, a period for its usage, etc. When it is not possible to comply with the condition for performing access for the access information, the attribute information acquisition device 2 does not require the attribute information management device 1 to send attribute information.

The access information management device 3 will be explained. The access information management device 3 receives and acquires first access information from the attribute information providing device 1 as access information and provides the same to the attribute information acquisition device 2. That is, the access information management device 3 sends it to the attribute information acquisition device 2. The access information management device 3 generates second access information as access information for the access information proxy management device 4 and sends it thereto.

FIG. 2 is a block diagram showing a configuration example of the access information management device 3. As shown in FIG. 2, the access information management device 3 includes an access information registering means 31, an access information management means 32, a use device confirmation accepting means 33, an attribute information acquisition device information storing means 34, an access information generating means 35, an access information sending means 36, a user information management means 37, an access information request accepting means 38, an access information acquiring means 39 and an access information providing means 30.

The access information registering means 31 receives access information necessary to access attribute information from the attribute information management device 1 and registers it in the access information management means 32. Concretely, the access information registering means 31 receives and acquires first access information for acquiring the attribute information from the attribute information management device 1 and registers the same in the access information management means 32. The first access information obtained here includes information indicative of IDs for uniquely identifying the URL of the attribute information management device 1 and a user issued by the attribute information management device 1, the type of attribute information held in the attribute information management device 1, etc.

The access information management means 32 stores the first access information being the access information received from the attribute information management device 1.

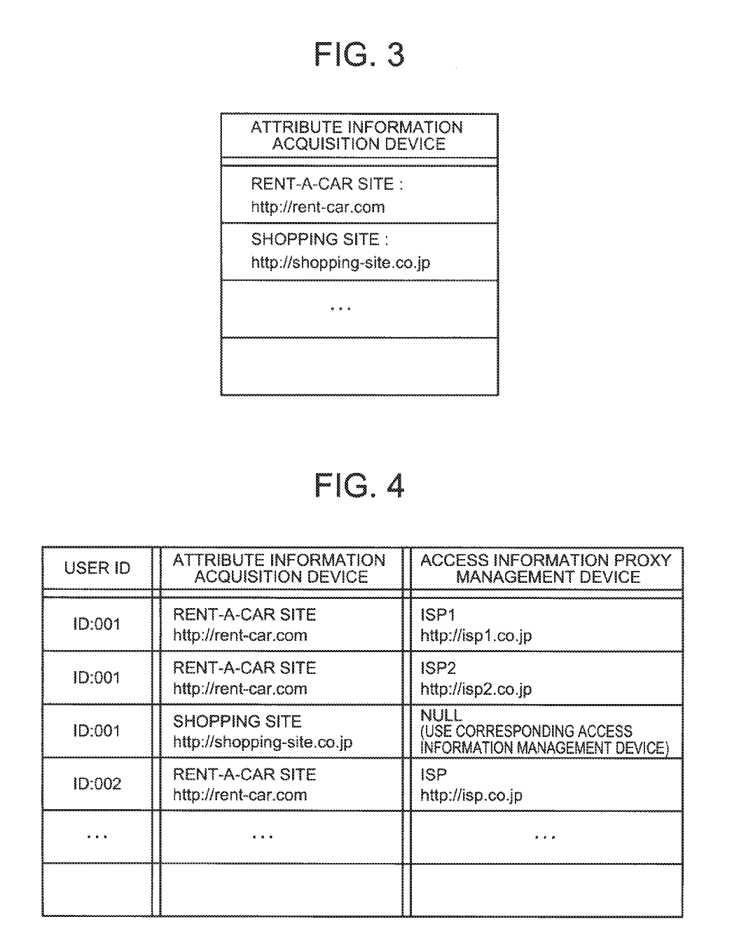

The use device confirmation accepting means 33 acquires from the user terminal 5, a list for the attribute information acquisition device 2 indicative of access information provided by the access information management device 3, which list is indicative of a list for the attribute information acquisition device 2 for acquiring the access information. FIG. 3 is an explanatory diagram showing an example of a list for the attribute information acquisition device 2. In the example shown in FIG. 3, URLs of a plurality of websites such as a rent-a car site, a shopping site and so on have been described in the list for the attribute information acquisition device 2.

The use device confirmation accepting means 33 acquires from the attribute information acquisition device information storing means 34, a list for each access information proxy management device 4 which is used in the attribute information acquisition device 2 described in the list illustrated in FIG. 3.

The attribute information acquisition device information storing means 34 stores the list for the access information proxy management device 4 used in the attribute information acquisition device 2. FIG. 4 is an explanatory diagram showing the list for the access information proxy management device 4 stored in the attribute information acquisition device information storing means 34. Each user ID in the example shown in FIG. 4 is an ID for identifying a user for the user terminal 5. The user ID is shared in advance by the attribute information acquisition device 2 and the access information proxy management device 4. That is, the attribute information acquisition device 2 and the access information proxy management device 4 identify a user by using the corresponding user ID.

The access information generating means 35 generates second access information being access information corresponding to each individual device described in the list of the access information proxy management device 4 which has been acquired by the use device confirmation accepting means 33. Here, the second access information generated by the access information generating means 35 is information which is different from the first access information corresponding to the access information acquired by the access information registering means 31 from the attribute information management device 1. The second access information is information which is necessary for the access information management device 3 to acquire the corresponding first access information stored in the access information management means 32.

The second access information includes, for example, information indicative of IDs for uniquely identifying the URL of the access information management device 3 and a user issued by the access information management device 3, and the type of attribute information included in the first access information corresponding to the access information held by the access information management means 32. The second access information being the access information generated by the access information generating means 35 may be information different every access information proxy management device 4.

The access information sending means 36 sends the access information generated by the access information generating means 35 to each individual device described in the list for the access information proxy management device 4 acquired by the use device confirmation accepting means 33.

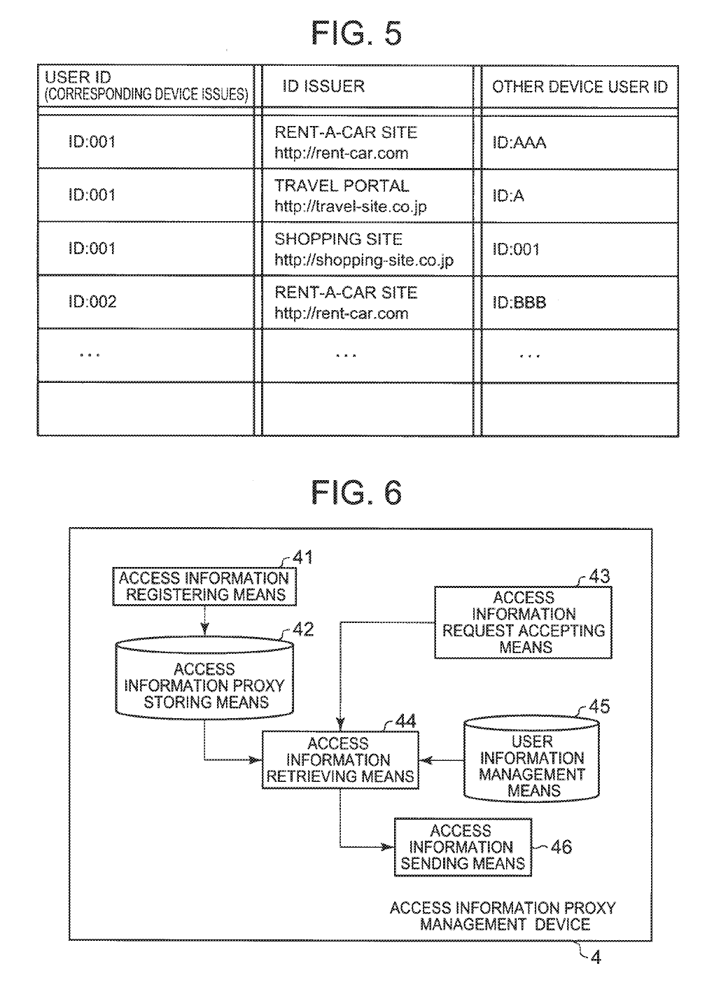

The user information management means 37 stores and holds information about user IDs necessary for the access information generating means 35 to generate the access information. FIG. 5 is an explanatory diagram showing the information about the IDs stored in the user information management means 37. As shown in FIG. 5, the user information management means 37 stores therein user IDs (shown in the left column of FIG. 5) used in the second access information and user IDs (shown in the right column of FIG. 5) used in the first access information, in association with one another. The user IDs used in the second access information are user IDs issued by the access information management device 3 and shared between the access information management device 3 and the access information proxy management device 4. The user IDs used in the first access information are user IDs used for the attribute information providing device 1 to identify users identified by the access information management device 3 according to the corresponding user IDs. The attribute information providing device 2 having sent the first access information as the access information is shown in the middle column of FIG. 5. Incidentally, each information shown in FIG. 5 is stored in the user information management means 37 when the access information management device 3 generates the second access information.

The access information request accepting means 38 receives a request message which requires the attribute information acquisition device 2 to send access information. Information indicative of each user ID included in the first access information being the access information generated by the access information generating means 35, and the type of necessary attribute information are described in the request message.

The access information acquiring means 39 acquires first access information as access information corresponding to the request message from the access information management means 32. For example, the access information acquiring means 39 converts a user ID described in the request message received by the access information request accepting means 38 using the information stored in the user information management means 37. Concretely, when the user ID described in the request message coincides with any user ID shown in the right column of FIG. 5, the access information acquiring means 39 converts the user ID to the user ID shown in the left column of FIG. 5. Then, the access information acquiring means 39 acquires the corresponding access information from the access information management means 32, based on the post-conversion user ID and the type of attribute information.

The access information providing means 30 sends the first access information corresponding to the access information acquired by the access information acquiring means 39 to the attribute information acquisition device 2.

The access information proxy management device 4 will be explained. The access information proxy management device 4 acquires second access information from the access information management device 3 as access information and sends it to the attribute information acquisition device 2. That is, the access information proxy management device 4 sends the second access information received from the access information management device 3 to the attribute information acquisition device 2.

FIG. 6 is a block diagram showing a configuration example of the access information proxy management device 4. As shown in FIG. 6, the access information proxy management device 4 includes an access information registering means 41, an access information proxy storing means 42, an access information request accepting means 43, an access information retrieving means 44, a user information management means 45 and an access information sending means 46.

The access information registering means 41 receives second access information from the access information management device 3 as access information and registers the received second access information in the access information proxy storing means 42. The access information proxy storing means 42 stores therein the registered second access information corresponding to the access information.

The user information management means 45 stores user's identifier information therein. The stored identifier information includes content (content illustrated in FIG. 5) similar to that of the user information management means 37 in the access information management device 3.

The access information request accepting means 43 receives a message that requires the attribute information acquisition device 2 to send access information. An identifier uniquely indicating a user, the type of attribute information required by the attribute information acquisition device 2, etc. have been described in the corresponding message.

The access information retrieving means 44 acquires necessary access information from the access information storing means 42 according to the corresponding message. For example, the access information retrieving means 44 converts the identifier described in the message to a user ID corresponding to the identifier described in the second access information, based on the identifier information being the information held by the user information management means 45. The access information retrieving means 44 acquires the second access information from the access information storing means 42 as necessary access information, based on the post-conversion identifier and the type of attribute information described in the message. Incidentally, a process conducted by the access information retrieving means 44 is similar to the process carried out by the access information acquiring means 39.

The access information sending means 46 sends the second access information being the access information acquired by the access information retrieving means 44 to the attribute information acquisition device 2.

The user terminal 5 sends the list for the attribute information acquisition device 2 used by a user to the access information management device 3 according to the user' operation.

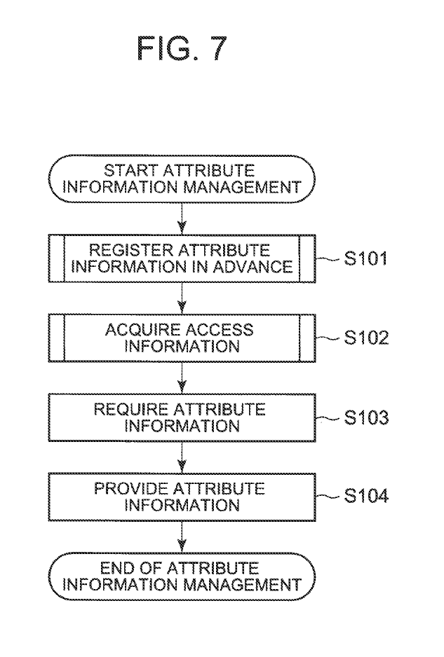

The operation of the attribute information sharing providing system according to the exemplary embodiment 1 of the present invention will next be described. FIG. 7 is a flowchart showing an operation for providing the attribute information acquisition device with attribute information sent by the user terminal 5. Incidentally, FIG. 7 shows an example in which the attribute information acquisition device 2 acquires the first access information from the access information management device 3 foremost without receiving the second access information from the access information proxy management device 4.

First, the user terminal 5 registers attribute information in the attribute information providing device 1, and the attribute information providing device 1 registers first access information being access information to the attribute information in the access information management device 3 (Step S101). This is an advanced registration process and is carried out before the attribute information is provided to the attribute information acquisition device 2. The content of the process of Step S101 will be described later.

Next, the attribute information acquisition device 2 that needs attribute information acquires the first access information corresponding to the access information registered in the access information management device 3 (Step S102). The content of the process of Step S102 will be described later. The process of Step S102 is not necessarily performed immediately after the process of Step S101. If the process of Step S101 has been completed, the attribute information acquisition device 2 may perform processes subsequent to Step S102 with desired timings.

Further, the attribute information acquisition device 2 having acquired the first access information registered in the access information management device 3 generates a request message that requests the transmission of attribute information from the attribute information providing device 1, described in the first access information and sends the same thereto (Step S103). Last, the attribute information providing device 1 having received the request message sends the attribute information to the attribute information acquisition device 2 according to the request (Step S104).

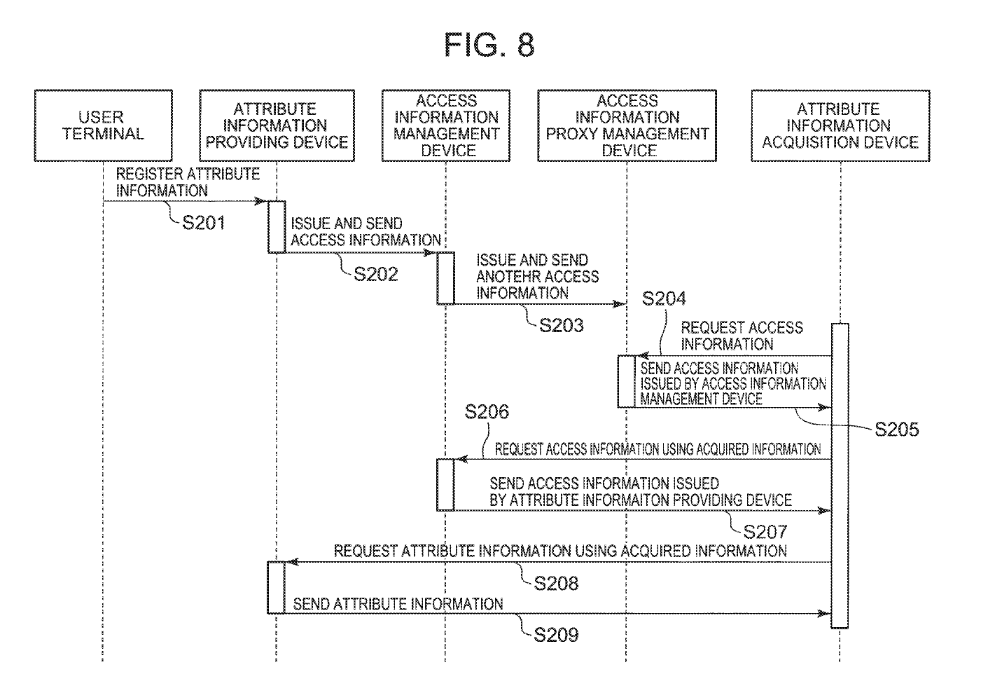

The process of providing the attribute information sent by the user terminal 5 to the attribute information acquisition device 2 will be explained using a sequence diagram shown in FIG. 8. FIG. 8 is a sequence diagram showing the process of providing the attribute information sent by the user terminal 5 to the attribute information acquisition device 2. A process for registering the attribute information will first be described.

A user registers attribute information in the attribute information providing device 1 via the user terminal 5 (Step S201). Next, the attribute information providing device 1 issues first access information being access information for accessing the attribute information providing device itself and sends the same to the access information management device 3 (Step S202). Then, the access information management device 3 issues second access information different from the first access information issued by the attribute information providing device 1 and sends the same to the access information proxy management device 4 (Step S203). Information for accessing the access information management device 3 has been described in the second access information. When the access information proxy management device 4 acquires the second access information, the second access information is stored in the access information proxy management device 4. The registration process of the attribute information is completed according to the above-described processing.

A process for acquiring attribute information will next be explained. First, the attribute information acquisition device 2 requires the access information proxy management device 4 to send access information (Step S204). Then, the access information proxy management device 4 sends the second access information acquired from the access information management device 3 to the attribute information acquisition device 2 (Step S205).

Next, the attribute information acquisition device 2 requires the access information management device 3 to send access information, based on the information described in the second access information sent at the process of Step S205 (Step S206). Then, the access information management device 3 sends the first access information corresponding to the access information acquired from the attribute information providing device 1 to the attribute information acquisition device (Step S207). Next, the attribute information acquisition device 2 requires the attribute information providing device 1 to send attribute information about a user, based on the first access information being the access information sent and acquired at the process of Step S207 (Step S208). In doing so, the attribute information providing device 1 sends attribute information to the attribute information acquisition device 2 (Step S209). The process of acquiring the attribute information is ended according to the above processing.

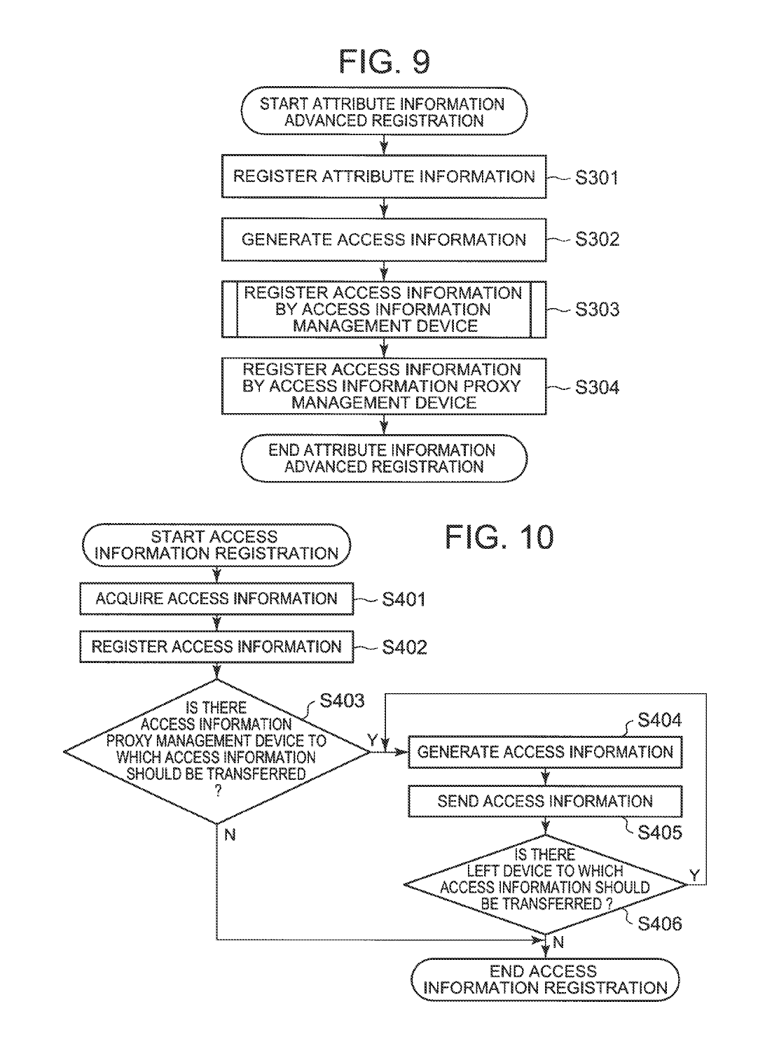

An advanced registration of attribute information corresponding to the process of Step S101 shown in FIG. 7 will next be explained. FIG. 9 is a flowchart showing the process of registering the attribute information in advance.

First, the user terminal 5 registers user's attribute information in the attribute information providing device 1 (Step S301). Next, the attribute information providing device 1 generates information for accessing the attribute information held in itself, as access information (Step S302). Further, the attribute information providing device 1 sends first access information being the generated access information to the access information management device 3, where the first access information is registered (Step S303).

A description will now be made of the process (process of Step S303 shown in FIG. 9) of registering the access information by the access information management device 3. FIG. 10 is a flowchart showing the process for registering the access information by the access information management device 3.

First, the access information registering means 31 acquires first access information from the attribute information providing device 1 as access information (Step S401). Next, the access information registering means 31 registers the first access information acquired by the process of Step S401 in the access information management means 32 (Step S402).

Thereafter, the use device confirmation accepting means 33 acquires from the user terminal 5, a list for the attribute information acquisition device 2 that utilizes attribute information. The use device confirmation accepting means 33 compares the list acquired here and the list stored in the attribute information acquisition device information storing means 34 and determines whether access information should be sent to another access information proxy management device 4 (Step S403). For example, when the use device confirmation accepting means 33 acquires the list illustrated in FIG. 3 and the attribute information acquisition device information storing means 34 holds the list illustrated in FIG. 4, the access information proxy management devices 4 called ISP1 and ISP2 are utilized. It is therefore determined that the access information management device 3 sends second access information to the two access information proxy management devices 4 called ISP1 and ISP2 as access information. If it is determined at the process of Step S403 that the access information is not provided to the access information proxy management devices 4 corresponding to other devices (N at Step S403), the process of registering the access information is completed and the attribute information registration process is ended.

When it is determined at the process of Step S403 that the access information is provided to the access information proxy management devices 4 corresponding to other devices (Y at Step S403), the access information generating means 35 generates second access information being access information for providing to the access information proxy management devices 4, using the information stored in the user information management means 37 (Step S404). The information for acquiring the first access information being the access information that has accessing to the access information management device 3 itself and is issued by the attribute information providing device 1, is described in the second access information corresponding to the access information generated at this time. Concretely, there is described therein an identifier for uniquely specifying the URL of the access information management device 3 itself or a user issued by the access information management device 3 itself.

Next, the access information sending means 36 sends the second access information being the access information generated by the access information generating means 35 to the access information proxy management device 4 (Step S405). Thereafter, the access information generating means 35 confirms whether or not to send access information to another access information proxy management device 4 (Step S406). If it is necessary to send the access information (Y at Step S406), the processes of Steps S404 and S405 are repeated again. When it is determined at the process of Step S406 that there is no need to send the access information (N at Step S406), the access information management device 3 ends the process of registering the access information and ends the attribute information registration process.

Thereafter, the access information registering means 41 of the access information proxy management device 4 receives second access information from the access information management device 3 as access information. The access information proxy storing means 42 registers the received second access information being the access information therein (Step S304). If the access information management device 3 has determined at the process of Step S403 that the access information is not sent to other devices, the process of Step S304 is not carried out. The process of Step S304 is carried out by all the access information proxy management devices 4 to which the access information management device 3 has sent the access information.

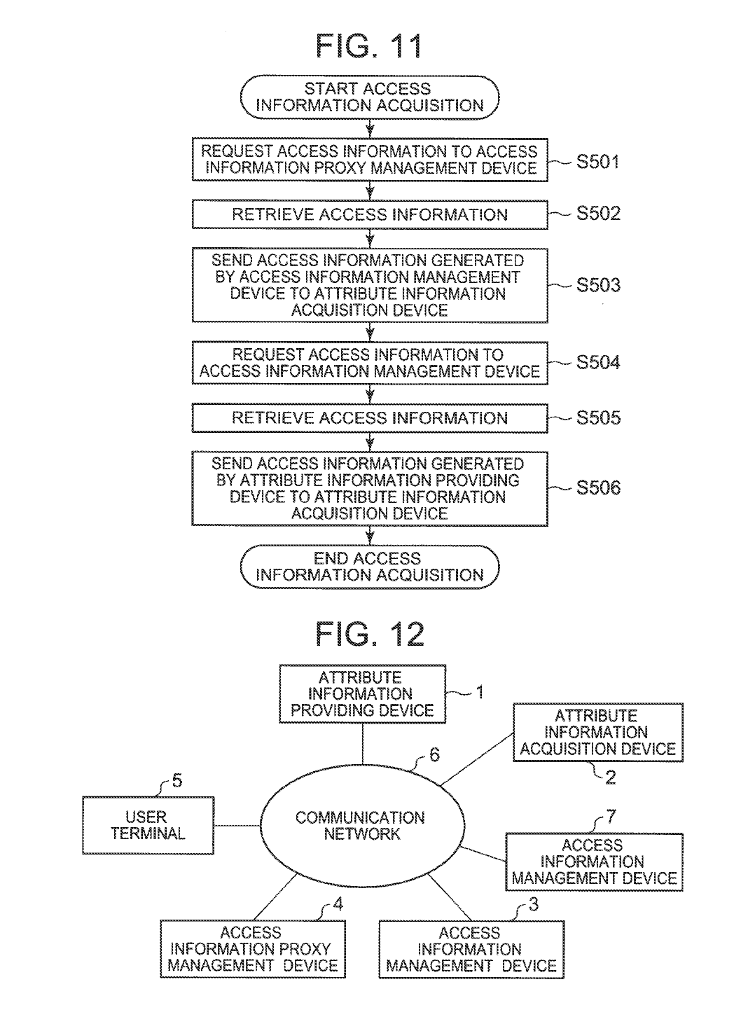

A description will next be made of a process for acquiring access information by the attribute information acquisition device 2, which corresponds to the process of Step S102 shown in FIG. 7. FIG. 11 is a flowchart showing the process of acquiring the access information by the attribute information acquisition device 2.

First, the attribute information acquisition device 2 that needs attribute information sends a request message for requiring the access information management device 3 or the access information proxy management device 4 to send access information for the purpose of obtaining the access information. If the request message is sent not to the access information proxy management device 4 but to the access information management device 3, processing is started from Step S504 shown in FIG. 11. Now assume that the request message is sent to the access information proxy management device 4 (Step S501). An identifier uniquely showing a user, the type of attribute information required by the attribute information acquisition device 2, etc. are described in the request message.

Next, when the access information request accepting means 43 receives the request message therein, the access information retrieving means 44 retrieves and acquires second access information from the access information storing means 42 as access information corresponding to the request message (Step S502). For example, the access information retrieving means 44 converts the identifier described in the request message, based on the information held by the user information management means 45 and retrieves and obtains second access information being necessary access information from the post-conversion identifier and the type of attribute information described in the message. The access information to be acquired here is not the first access information being the access information issued by the attribute information providing device 1 but the second access information being the access information issued by the access information management device 3. Thereafter, the access information sending means 46 sends the acquired second access information to the attribute information acquisition device 2 (Step S503).

Next, the attribute information acquisition device 2 having acquired the second access information as the access information sends a request message for requiring the access information management device 3 of the URL described in the second access information to send access information to the access information management device 3 (Step S504).

When the access information request accepting means 38 of the access information management device 3 receives the request message therein, the access information acquiring means 39 retrieves and obtains firs access information being access information corresponding to the request message from the access information storing means 32 (Step S505). The access information acquired here corresponds to the first access information being the access information issued by the attribute information providing device 1. The acquisition process of Step S505 is similar to the access information retrieving process carried out at the process of Step S502 by the access information proxy management device 4. Next, the access information providing means 30 sends to the attribute information acquisition device 2 the first access information corresponding to the access information acquired by the access information acquiring means 39 (Step S506).

In the present embodiment, the access information management device 3 is configured so as to send the second access information to the access information proxy management devices corresponding to other devices as the access information. Therefore; the attribute information providing device 1 needs not to provide the first access information to a plurality of access information management devices 3 as the access information. Thus, it is possible to prevent an increase in risk of leakage of the attribute information that would otherwise occur when the first access information including the URL and the like of the attribute information management device 1 for managing the attribute information is sent to many access information management devices 3 or when the number of devices for managing the sent first access information increases.

In the present embodiment as well, the attribute information acquisition device 2 is configured so as to be able to acquire the first access information being the access information issued by the attribute information providing device 1 in response to at most two transmission requests of access information. The attribute information acquisition device 2 is therefore able to access the attribute information efficiently. That is, the attribute information can efficiently be acquired.

Further, the present exemplary embodiment is so configured that the user's identifier can be changed every device to which the identifier is sent. It is therefore possible to prevent computer-assisted name identification between devices in which attribute information are integrated into one against user's will and to protect privacy of a user, thereby making it possible to protect the privacy of each user.

### Exemplary Embodiment 2

An exemplary embodiment 2 of an attribute information sharing providing system according to the present invention will be explained with reference to the accompanying drawings. FIG. 12 is a block diagram showing a configuration example of the exemplary embodiment 2 of the attribute information sharing providing system according to the present invention.

As shown in FIG. 12, the attribute information sharing providing system according to the exemplary embodiment 2 of the present invention is different from the attribute information sharing providing system according to the exemplary embodiment 1 shown in FIG. 1 in that it includes an access information management device 7 in addition to the configuration of the attribute information sharing providing system according to the exemplary embodiment 1.

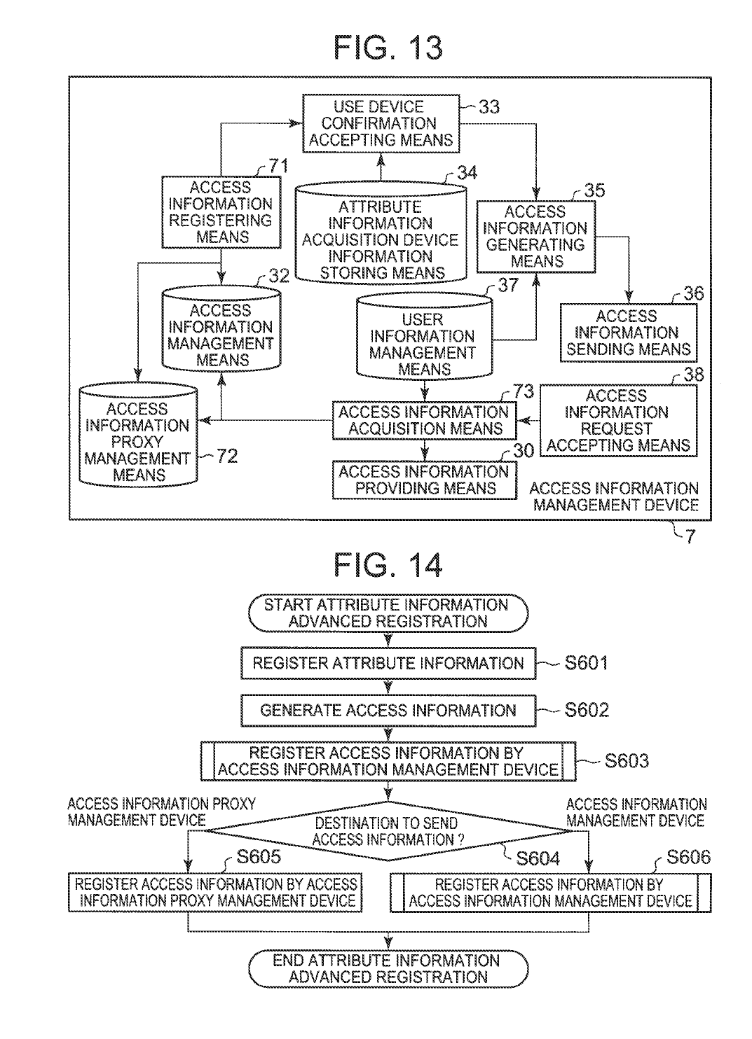

FIG. 13 is a block diagram showing a configuration example of the access information management device 7. As shown in FIG. 13, the access information management device 7 includes an access information registering means 71 instead of the access information registering means 31 in the configuration of the access information management device 3 in the exemplary embodiment 1 shown in FIG. 2. The access information management device 7 includes an access information acquiring means 73 instead of the access information acquiring means 39 and further includes an access information proxy management means 72.

The access information registering means 71 receives first access information or second access information from another device as access information and registers it in the access information management means 32 or the access information proxy management means 72. If the access information registering means 71 receives first access information from the attribute information providing device 1, the access information registering means 71 registers the first access information in the access information management means 32. When the access information registering means 71 receives second access information from the access information management device 3, the access information registering means 71 registers the second access information in the access information management means 72.

The access information proxy management means 72 stores therein the second access information corresponding to access information, which has been received from the access information management device 3. The access information acquiring means 73 retrieves and acquires the access information stored in the access information management device 7. A target for retrieval is the first access information or the second access information corresponding to the access information stored in the access information management means 32 or the access information management means 72.

The operation of the attribute information sharing providing system according to the exemplary embodiment 2 of the present invention will next be explained. The operation of providing attribute information sent by the user terminal 5 in the exemplary embodiment 2 to the attribute information acquisition device 2 is different in terms of a process for attribute information advanced registration corresponding to the process of Step S101 shown in FIG. 7 and an access information acquiring process corresponding to the process of Step S102 shown in FIG. 7, as compared with the operation of providing the attribute information sent by the user terminal 5 in the exemplary embodiment 1 shown in FIG. 7 to the attribute information acquisition device 2. The present attribute information sharing providing system is similar in other operation to the attribute information sharing providing system according to the exemplary embodiment 1.

FIG. 14 is a flowchart showing the process for attribute information advanced registration in the exemplary embodiment 2. Since processes of Steps S601 and S602 in the process for the attribute information advanced registration in the exemplary embodiment 2 shown in FIG. 14 are similar to the processes of Steps S301 and S302 in the process for the attribute information advanced registration in the exemplary embodiment 1 shown in FIG. 9, their description will be omitted.

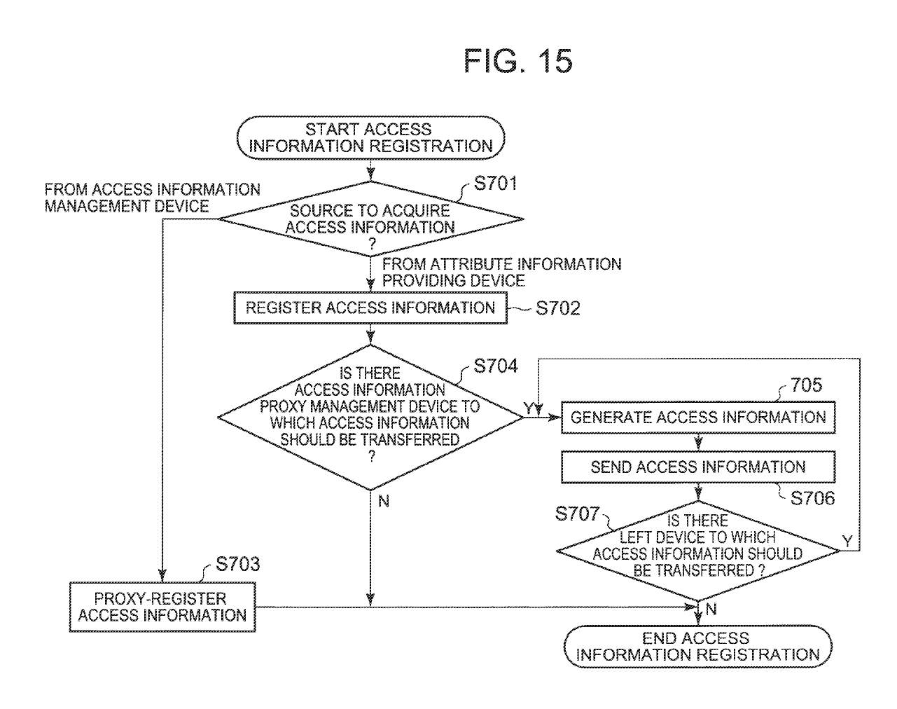

FIG. 15 is a flowchart showing a process for registering access information by the access information management device 7 in the exemplary embodiment 2. Incidentally, the process for registering the access information by the access information management device 7 in the exemplary embodiment 2, which is shown in FIG. 15, corresponds to the process of Step S603 shown in FIG. 14 and is a process corresponding to the process of Step S303 in the exemplary embodiment 1, which is shown in FIG. 9.

When the access information registering means 71 of the access information management device 7 receives access information from another device, the access information registering means 71 determines whether the source of the access information corresponds to another access information management device 3 or the attribute information providing device 1 (Step S701). If the access information registering means 71 has received access information from the attribute information providing device 1, it registers the access information in the access information management means 32 (Step S702).

If it is determined at the process of Step S701 that the access information has been received from another access information management device 3, then the access information registering means 71 registers the access information in the access information proxy management means 72 (Step S703).

Since processes of Steps S704 through S707 are similar to the processes of Steps S403 through S406 in the exemplary embodiment 1, which are shown in FIG. 10, their description will be omitted.

When it is determined at the process of Step S704 shown in FIG. 15 that the access information management device 7 transfers the access information to other devices, processes differ depending on the devices being destinations (Step S604). When the access information management device 7 transfers access information to the access information proxy management device 4, the access information proxy management device 7 manages attribute information (Step S605). Since the process of Step S605 is similar to the process of Step S304 shown in FIG. 9, its description will be omitted. If access information is sent to another access information management device 3, another access information management device 3 having received the access information therein performs an operation similar to Step S603 shown in FIG. 14 (Step S606).

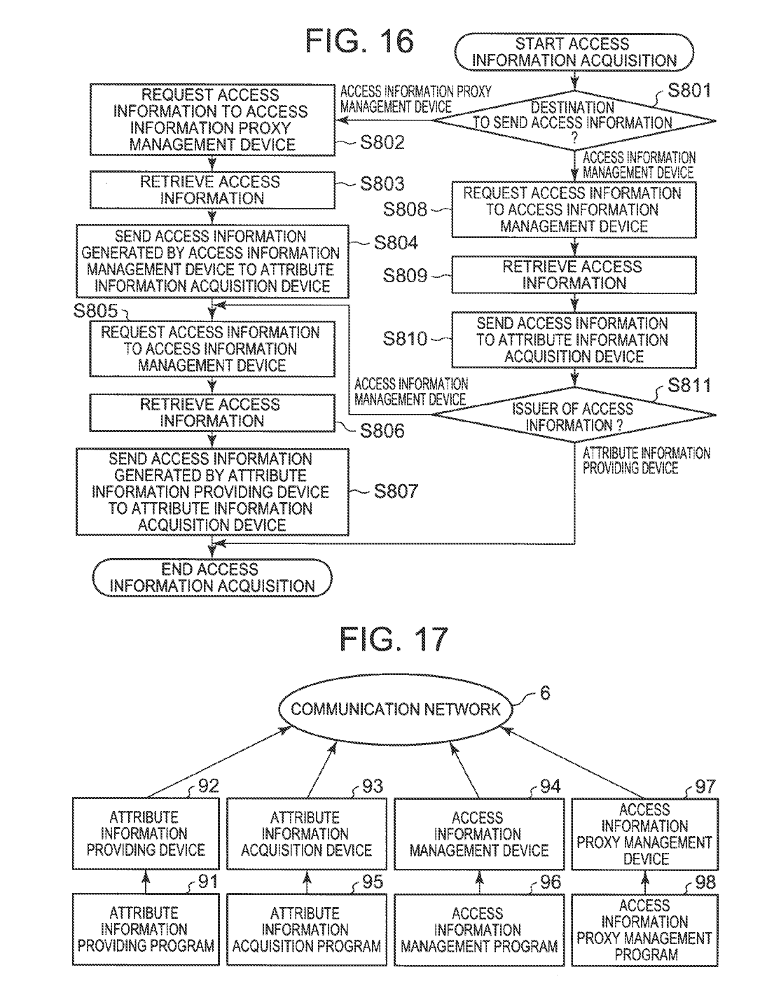

An access information acquiring process in the present embodiment corresponding to the process of Step S101 in the exemplary embodiment 1, which is shown in FIG. 7, will next be explained with reference to the drawing. FIG. 16 is a flowchart showing the access information acquiring process in the exemplary embodiment 2.

First, the attribute information acquisition device 2 determines a device that requests the transmission of access information (Step S801). Then, when the attribute information acquisition device 2 acquires access information from the access information proxy management device 4, the attribute information acquisition device 2 performs processes similar to the processes of Steps S501 through S506 in the access information acquiring process of the exemplary embodiment 1, which are shown in FIG. 11 (Steps S802 through S807).

When the attribute information acquisition device 2 requires the access information management device 7 to send access information, the attribute information acquisition device 2 generates a request message for requesting the transmission of the access information and sends it to the access information management device 7 (Step S808). The request message is received by the access information request accepting means 38.

The access information acquiring means 73 retrieves and acquires access information from the access information management means 32 or the access information proxy management means 72 (Step S809). The process of Step S809 is similar to the process of S502 in the exemplary embodiment 1, which is shown in FIG. 11.

The access information providing means 30 sends the access information acquired by the access information acquiring means 73 to the attribute information acquisition device 2 (Step S810). Next, the attribute information acquisition device 2 verifies an issuer of the access information (Step S811). Incidentally, the verification of the issuer of the access information means the execution of a process for acquiring the URL for accessing an attribute information management server from the access information. If the attribute information providing device 1 issues the access information, then the access information acquiring process is completed. When another access information management device 3 has issued the access information, the attribute information acquisition device 2 performs a process for requiring another access information management device 3 to send the access information (Step S805). Processes subsequent to Step S805 are similar to the access information acquiring process in the exemplary embodiment 1, which corresponds to the processes of Steps S504 through S506 shown in FIG. 11.

In the present embodiment, the access information management device 7 can be operated as the access information proxy management device and is configured in such a manner that more devices are able to have access information to attribute information. Therefore, the attribute information acquisition device 2 is able to acquire the access information from the more devices.

### Exemplary Embodiment 3

An exemplary embodiment 3 of an attribute information sharing providing system according to the present invention will be explained with reference to the drawing. FIG. 17 is a block diagram showing a configuration example of the exemplary embodiment 3 of the attribute information sharing providing system according to the present invention.

In the attribute information sharing providing system of the exemplary embodiment 3 of the present invention, the respective devices in the first and exemplary embodiment 2s are respectively loaded with programs and operated in accordance with control of the programs.

An attribute information providing program 91 controls the operation of an attribute information providing device 92 to provide attribute information to an attribute information acquisition device 93 and provide access information to an access information management device 94. The attribute information providing device 92 executes a process similar to the attribute information providing devices 1 in the exemplary embodiments 1, 2 under the control of the attribute information providing program 91.

An attribute information acquiring program 95 controls the operation of the attribute information acquisition device 93 to acquire access information from the access information management device 94 and an access information proxy management device 96 and acquire attribute information from the attribute information providing device 92. The attribute information acquisition device 93 executes a process similar to the attribute information acquisition devices 2 in the exemplary embodiments 1, 2 under the control of the attribute information acquiring program 95.

An access information managing program (also called an access information managing program) 96 controls the operation of the access information management device 94 to acquire access information from the attribute information providing device 92, distribute access information to an access information proxy management device 97 and provide access information in response to a request from the attribute information acquisition device 93. The access information management device 94 carries out a process similar to the processes done by the access information providing device 1 and the access information providing device 7 in the exemplary embodiments 1, 2 under the control of the access information managing program 96.

An access information proxy managing program (also called an access information proxy managing program) 98 controls the operation of the access information proxy management device 97 to acquire access information from the access information management device 94 and provide access information in response to a request from the attribute information acquisition device 93. The access information proxy management device 97 performs a process similar to the processes done by the access information proxy management devices 4 in the exemplary embodiments 1, 2 under the control of the access information proxy managing program 98.

The access information managing program 96 is a program which causes a computer to execute an access information managing process for managing first access information for accessing an attribute information providing device 92, which is issued by the attribute information providing device 92 which manages attribute information corresponding to information related to each user, a second access information issuing process for generating second access information having described information for accessing the corresponding access management device 94 sending information for accessing the attribute information providing device 92 and for sending the second access information to the access information proxy management device 97 sending the second access information to the attribute information acquisition device 93 using the attribute information, and a first access information sending process for, when the transmission of the access information is requested from the attribute information acquisition device 93 having acquired the second access information, sending first access information to the attribute information acquisition device 93 in response to the request.

The access information proxy managing program 98 is a program that causes a computer to execute an access information proxy managing process for storing access information acquired from the access information management device 94 that sends information for accessing the attribute information providing device 92 for managing attribute information to the attribute information acquisition device 93 that uses attribute information being information related to each user, an access information retrieving process for, when the transmission of the access information is requested from the attribute information acquisition device 93, acquiring access information corresponding to the request out of the stored access information, and a process for sending the access information acquired by the access information retrieving process to the attribute information acquisition device 93.

### Example

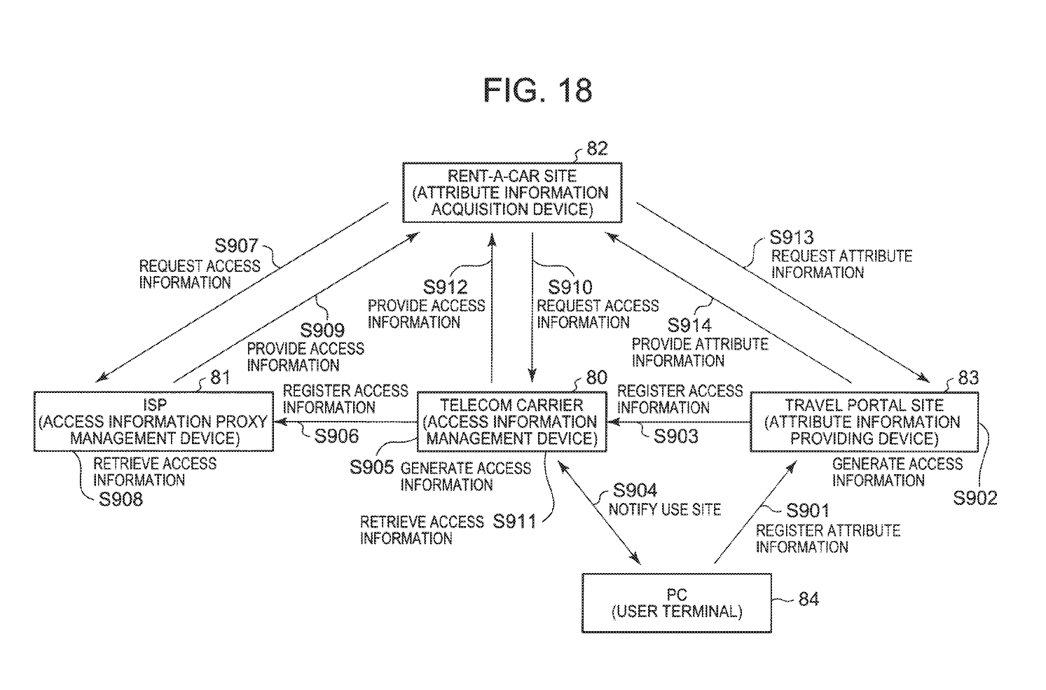

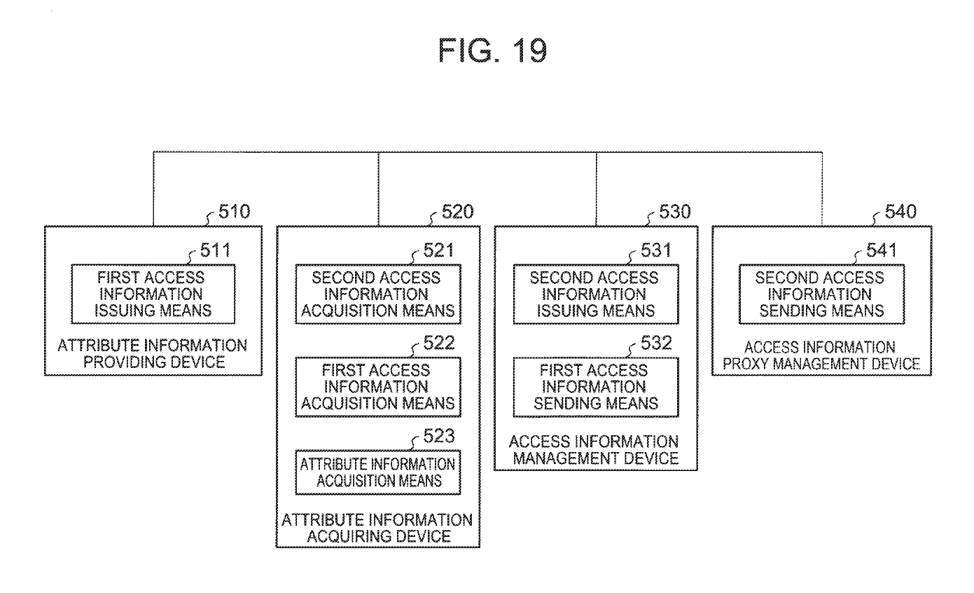

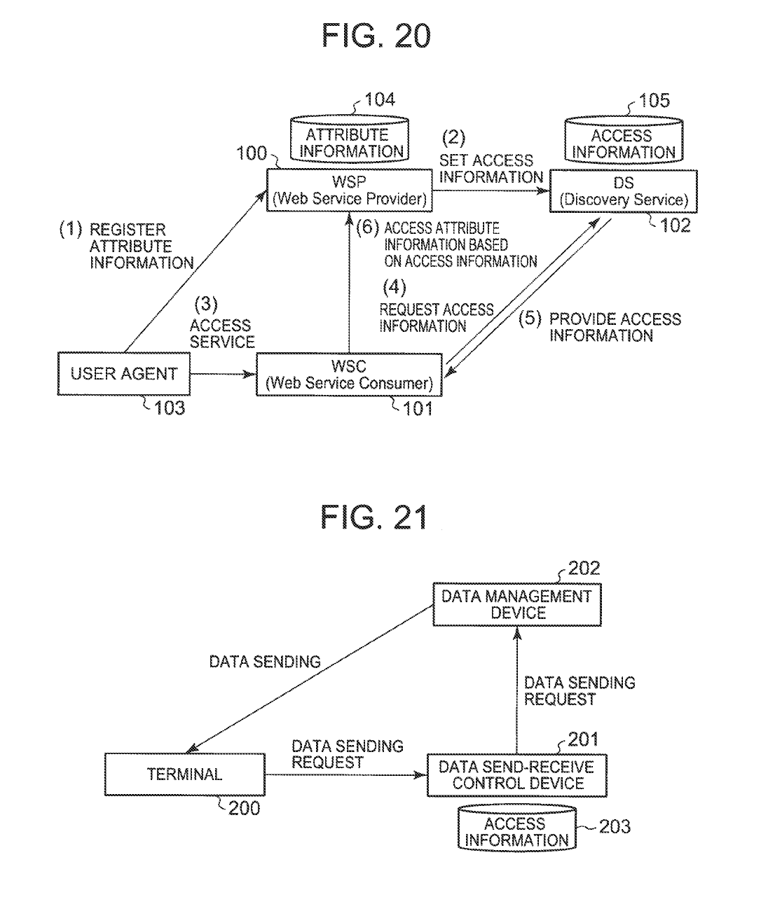

The operation of the attribute information sharing providing system according to the present invention will next be explained using a concrete example. FIG. 18 is an explanatory diagram illustrating a configuration of an example of the attribute information sharing providing system according to the present invention.

As shown in FIG. 18, the attribute information sharing providing system of the present example includes a telecom carrier 80 which acts as an access information management device that manages access information and provides first access formation to another device as access information via a communication network such as Internet, an Internet service provider (ISP) 81 that receives the first access information from the telecom carrier 80 as the access information and acts as an access information proxy management device which provides second access information being access information based on the received first access information to another business proprietor, a rent-a-car site 82 which acts as an attribute information acquisition device, and a travel portal site 83 which acts as an attribute information providing device. A PC (Personal Computer) 84 which acts as a user terminal subject to the provision of services via the communication network is connected to the respective devices via the communication network.

Incidentally, the telecom carrier 80 is, for example, a server installed by a business proprietor that provides telecommunications services.

In the present example, a user is assumed to register attribute information in the travel portal site 83 via the PC 84 and utilize services provided by the rent-a-car site 82 using the registered attribute information.

For example, the rent-a-car site 82 acquires the name of each user, an address and a telephone number thereof indicative of a contact address thereof using the attribute information held in the travel portal site 83. To this end, the travel portal site 83 generates first access information as access information, and the telecom carrier 80 and the ISP 81 store therein the first access information and second access information as the access information.

In the present example, the telecom carrier 80 is assumed to have known in advance the relationship between the rent-a-car site 82 and the ISP 81. That is, the telecom carrier 80 is assumed to have held information that the rent-a-car site 82 utilizes the ISP 81 as a retrieval destination of access information. Under this situation, the rent-a-car site 82 acquires attribute information from the travel portal site 83.

First, the user obtains access to the services (concretely, e.g., a server for realizing the travel portal site 83) of the travel portal site 83 via the PC 84 and registers attribute information as user information (Step S901). At this time, the travel portal site 83 generates first access information being access information corresponding to the user information as well as storing the user information therein (Step S902).

Thereafter, the travel portal site 83 sends the access information to the telecom carrier 80 (Step S903). When the telecom carrier 80 receives the access information therein, an access information management means of the telecom carrier 80 that corresponds to the access information management means 32 shown in FIG. 2, holds it therein. To determine to which site access information should be distributed, a use device confirmation accepting means equivalent to the use device confirmation accepting means 33 shown in FIG. 2 acquires information related to an attribute information acquisition device from the PC 84 (Step S904).

Assume here that the telecom carrier 80 has acquired information that a user makes use of the rent-a-car site 82. When the information is acquired, an access information generating means acquires information by the ISP 81 used in the rent-a-car site 82 and generates access information for the ISP 81 (Step S905). That is, the access information generating means of the telecom carrier 80 equivalent to the access information generating means 35 shown in FIG. 2 generates second access information being access information used for sending to the ISP 81. For example, the access information generating means equivalent to the access information generating means 35 shown in FIG. 2 determines an access information proxy device for a destination of access information by reference to the list illustrated in FIG. 4. When a user whose user ID is ID: 002 makes use of the rent-a-car site 82 here, the telecom carrier 80 sends access information to the ISP 81. Here, the access information sent by the telecom carrier 80 is not the first access information being the access information generated by the travel portal site 83 but the second access information being the access information generated by the telecom carrier 80 itself. Next, the telecom carrier 80 sends the access information to the ISP 81 (Step S906).

In accordance with the above series of processes, the access information is assigned to the telecom carrier 80 and the ISP 81 corresponding to the respect business proprietors, and the pre-process for performing the sending/reception of the attribute information is ended.

The process of acquiring attribute information from the travel portal site 83 by the rent-a-car site 82 will next be explained.

First, the rent-a-car site 82 acquires information for accessing user's information to obtain the user's information. To this end, the rent-a-car site 82 requires the ISP 81 to send access information (Step S907). When the ISP 81 receives a request for the transmission of the access information therein, the ISP 81 retrieves the second access information being the access information acquired from the telecom carrier 80 at the process of Step S906 (Step S908) and sends the access information to the rent-a-car site 82 (Step S909). The access information acquired by the rent-a-car site 82 at the process of Step S909 is not the first access information being the access information issued by the travel portal site 83 having retained the attribute information therein, but the second access information being the access information issued by the telecom carrier 80.

The rent-a-car site 82 requires the telecom carrier 80 to send access information related to attribute information (Step S910). When the telecom carrier 80 receives this request therein, an access information acquiring means corresponding to the access information acquiring means 39 shown in FIG. 2 retrieves the first access information being the access information issued by the travel portal site 83 (Step S911).

Next, the telecom carrier 80 sends the first access information being the access information issued by the travel portal site 83 to the rent-a-car site 82 (Step S912). Since the rent-a-car site 82 has acquired the first access information issued by the travel portal site 83, the travel portal site 83 results in the acquisition of the information for requesting the attribute information. Therefore, the rent-a-car site 82 requires the travel portal site 83 to send attribute information (Step S913), and the travel portal site 83 sends the attribute information to the rent-a-car site 82 (Step S914).

According to the present example, since the telecom carrier 80 is configured so as to send the second access information to the ISP 81, the travel portal site 83 needs not to provide the first access information to a plurality of devices. Thus, this makes it possible to prevent the risk of leakage of the attribute information from increasing, which is caused by the sending to many devices, of the first access information including the URL and the like of the travel portal site 83 that manages the attribute information, and caused by increasing the number of devices for managing the sent first access information.

In the present example as well, the system is configured such that the rent-a-car site 82 is capable of acquiring the first access information issued by the travel portal site 83. Therefore, the rent-a-car site 82 is capable of acquiring the attribute information efficiently.

A summary of the present invention will next be explained. FIG. 19 is a block diagram showing the summary of the present invention. As shown in FIG. 19, an attribute information sharing providing system includes an attribute information providing device 510, an attribute information acquisition device 520, an access information management device 530 and an access information proxy management device 540.

The attribute information providing device 510 manages attribute information being information related to each user and provides the same to another device. The attribute information acquisition device 520 is another device which acquires the attribute information from the attribute information providing device 510. The access information management device 530 manages first access information for allowing the attribute information acquisition device 520 to access the attribute information providing device 510. The access information proxy management device 540 manages second access information for allowing the attribute information acquisition device 520 to access the access information management device 530.

The attribute information providing device 510 includes a first access information issuing means 511 which issues first access information for obtaining access to the attribute information providing device 510 for its own when attribute information is registered, and sends the same to the access information management device 530.

The access information management device 530 includes a second access information issuing means 531 (corresponding to the access information generating means 35 and access information sending means 36 shown in FIG. 3), and a first access information sending means 532 (corresponding to the access information providing means 30 shown in FIG. 3). When the access information management device 530 receives the first access information from the attribute information providing device 510, the second access information issuing means 531 issues second access information for obtaining access to the access information management device 530 for its own and sends the same to the access information proxy management device 530. The first access information sending means 532 sends first access information according to a request from the attribute information acquisition device 520.

The access information proxy management device 540 includes a second access information sending means 541 (corresponding to the access information sending means 46 shown in FIG. 6) which manages the second access information sent by the access information management device 530 and sends the second access information when the transmission of access information is requested from the attribute information acquisition device 520.

The attribute information acquisition device 520 includes a second access information acquiring means 521, a first access information acquiring means 522 and an attribute information acquiring means 523.

The second access information acquiring means 521 requires the access information proxy management device 540 to send access information and receives the second access information sent according to this request. The first access information acquiring means 522 requires the access information management device 530 to send access information, based on the second access information acquired by the second access information acquiring means 521 and receives the first access information sent according to this request. The attribute information acquiring means 523 requires the attribute information providing device 510 to send attribute information, based on the first access information acquired by the first access information acquiring means 522 and acquires the attribute information sent according to this request.

There has been disclosed in the above exemplary embodiment that the second access information issuing means 531 of the access information management device 530 issues a second access information having described an identifier different from a user identifier described in the first access information issued by the attribute information providing device. According to such a configuration, it is possible to prevent computer-assisted name identification between devices in which attribute information are integrated into one against user's will and to protect privacy of a user.

There has also been disclosed in the above-described exemplary embodiment that the access information management device 530 includes an access information storing means (equivalent to the access information proxy management means 72 shown in FIG. 13) which holds second access information received from another access information management device, and that when the transmission of access information is requested from the attribute information acquisition device 520, the first access information sending means 532 sends the first access information acquired from the attribute information providing device 510 or the second access information received from another access information management device and held by the access information storing means, to the attribute information acquisition device 520. According to such a configuration, the access information management device 530 can be operated as the access information proxy management device, and more devices are capable of having access information to attribute information. Further, the attribute information acquisition device 520 is capable of acquiring access information from more devices.

Although the invention of the present application has been described above with reference to the exemplary embodiments and examples, the invention of the present application is not limited to the above exemplary embodiments and examples. Various changes that are understandable by those skilled in the art within the scope of the invention of the present application can be made to the configuration and details of the invention of the present application.

This application claims priority based on Japanese Patent Application No. 2009-277951 filed on Dec. 7, 2009, the disclosure of which is incorporated herein in its entirety.

### INDUSTRIAL APPLICABILITY

The present invention can be applied to a device that manages user's information, a device that utilizes user's information, and a system in which a plurality of devices utilize user's information.

### REFERENCE SIGNS LIST

1, 510 Attribute information providing devices
2, 520 Attribute information acquisition devices
3, 7, 530 Access information management devices
4, 540 Access information proxy management devices
5 User terminal
6 Communication network
30 Access information providing means
31 Access information registering means
32 Access information management means
33 Use device confirmation accepting means
34 Attribute information acquisition device information storing means
35 Access information generating means
36 Access information sending means
37 User information management means
38 Access information request accepting means
39 Access information acquiring means
41 Access information registering means
42 Access information proxy storing means
43 Access information request accepting means
44 Access information retrieving means
45 User information management means
46 Access information sending means
71 Access information registering means
72 Access information proxy management means
73 Access information acquiring means
80 Telecom carrier
81 ISP
82 Rent-a-car site
83 Travel portal site
84 PC
91 Attribute information providing program
92 Attribute information providing device
93 Attribute information acquisition device
94 Access information management device
95 Attribute information acquiring program
96 Access information managing program
97 Access information proxy management device
98 Access information proxy managing program
511 First access information issuing means
521 Second access information acquiring means
522 First access information acquiring means
523 Attribute information acquiring means
531 Second access information issuing means
532 First access information sending means
541 Second access information sending means

1-18. (canceled)

19. An attribute information sharing providing system comprising:
an attribute information providing device which manages attribute information being information related to each user and provides the attribute information to another device;
an attribute information acquisition device corresponding to another device, the attribute information acquisition device acquiring the attribute information from the attribute information providing device;
an access information management device which manages first access information for accessing the attribute information providing device from the attribute information acquisition device; and
an access information proxy management device which manages second access information for accessing the access information management device from the attribute information acquisition device,
wherein the attribute information providing device includes first access information issuing means which when attribute information is registered, issues first access information for accessing the corresponding attribute information providing device and sends the first access information to the access information management device,
wherein the access information management device includes
second access information issuing means which when the first access information is received from the attribute information providing device, issues second access information for accessing the corresponding access information management device and sends the second access information to the access information proxy management device, and
first access information sending means which sends the first access information according to a request of the attribute information acquisition device,
wherein the access information proxy management device includes second access information sending means which manages the second access information sent by the access information management device and sends the second access information when the transmission of access information is requested from the attribute information acquisition device, and
wherein the attribute information acquisition device includes
second access information acquiring means which requires the access information proxy management device to send access information and receives the second access information sent according to the request,
first access information acquiring means which requires the access information management device to send access information, based on the second access information acquired by the second access information acquiring means and receives the first access information sent according to the request, and
attribute information acquiring means which requires the attribute information providing device to send the attribute information, based on the first access information acquired by the first access information acquiring means and acquires the attribute information sent according to the request.

20. The attribute information sharing providing system according to claim 19, wherein the second access information issuing means of the access information management device issues second access information descriptive of an identifier different from a user identifier described in the first access information issued by the attribute information providing device.

21. The attribute information sharing providing system according to claim 19, wherein the access information management device includes access information storing means which stores therein second access information received from another access information management device, and
wherein when the transmission of access information is requested from the attribute information acquisition device, the first access information sending means sends, to the attribute information acquisition device, the first access information acquired from the attribute information providing device or the second access information received from said another access information management device and stored in the access information storing means.

22. An access information management device comprising:
access information management means which manages first access information for accessing an attribute information providing device which manages attribute information being information related to each user, said first access information being issued by the attribute information providing device;
second access information issuing means which generates second access information descriptive of information for accessing a corresponding access information management device and sends the second access information to an access information proxy management device, the access information proxy management device sending the second access information to an attribute information acquisition device using the attribute information; and
first access information sending means which sends the first access information corresponding to a request of the attribute information acquisition device having acquired the second access information from the access information proxy management device.

23. The access information management device according to claim 22, including:
device information storing means which stores therein attribute information acquisition device information descriptive of a list of access information proxy management devices for which the attribute information acquisition device may request the transmission of access information, and
sending device determining means which acquires information related to an attribute information acquisition device used by a user from a terminal device of the user and determines an access information proxy management device corresponding to a destination of second access information, based on the acquired information and the attribute information acquisition device information stored in the device information storing means.

24. The access information management device according to claim 22, wherein the second access information issuing means generates second access information having described an identifier different from a user identifier described in the first access information by the attribute information providing device, and
wherein the access information management device includes user information management means which manages in association with each other, a user identifier described in the first access information to identify one user, and a user identifier described in the second access information generated by the second access information issuing means.

25. The access information management device according to claim 22, including:
access information proxy management means which acquires and manages second access information issued from another access information management device, and
access information providing means which when the transmission of access information is requested from the attribute information acquisition device, acquires first access information or second access information corresponding to the request from the access information management means or the access information proxy management means and provides the same to the attribute information acquisition device.

26. An access information proxy management device comprising:
access information proxy management means which manages access information for accessing an access information management device, the access information being received from the access information management device, said access information management device sending information for accessing an attribute information providing device that manages attribute information being information related to each user, to the attribute information acquisition device using the attribute information;
access information retrieving means which when the transmission of access information is requested from the attribute information acquisition device, acquires access information corresponding to the request from the access information proxy management means; and
sending/receiving means which sends the access information acquired by the access information retrieving means to the attribute information acquisition device.

27. An access information managing method comprising:
generating first access information for accessing a corresponding attribute information providing device which manages attribute information being information related to each user, said first access information being issued by the attribute information providing device, and sending the first access information to an access information management device which sends the first access information to a corresponding attribute information acquisition device using the attribute information;
generating second access information for accessing a corresponding access information management device, the second access information being issued by the access information management device, and sending the second access information to an access information proxy management device which sends the second access information to the attribute information acquisition device;
sending the second access information corresponding to a request of the attribute information acquisition device to the attribute information acquisition device;
sending first access information corresponding to a request of the attribute information acquisition device having acquired the second access information to the attribute information acquisition device; and
sending attribute information corresponding to a request of the attribute information acquisition device having acquired the first access information to the corresponding attribute information acquisition device.

28. The access information managing method according to claim 27, comprising:
managing attribute information acquisition device information descriptive of a list of access information proxy management devices for which the attribute information acquisition device may request the transmission of access information, and
acquiring information related to an attribute information acquisition device used by a user from a terminal device of the user and determining an access information proxy management device corresponding to a destination of second access information, based on the acquired information and the attribute information acquisition device information.

29. The access information managing method according to claim 27, comprising:
generating second access information having described an identifier different from a user identifier described in the first access information by the attribute information providing device, and
managing in association with each other, a user identifier described in the first access information to identify one user, and a user identifier described in the second access information to identify the one user.

30. The access information managing method according to claim 27, comprising:
acquiring and managing second access information issued from another access information management device, and
when the transmission of access information is requested from an attribute information acquisition device, sending first access information or second access information corresponding to the request to the attribute information acquisition device.
